(19) United States
(12) Patent Application Publication
(10) Pub. No.: US 2010/0065801 A1
(43) Pub. Date: Mar. 18, 2010

(54) MOBILE SUPPORT, ASSEMBLY WITH A FIRST AND A SECOND MOBILE SUPPORT AND TERRAIN DEMARCATION

(75) Inventors: Iwan Yves VLAAR, ZEGGE (NL); Karel VAN DEN BERG, BLESKENSGRAAF (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: MAASLAND N.V., Maassluis (NL)

(21) Appl. No.: 12/622,446

(22) Filed: Nov. 20, 2009

Related U.S. Application Data
(63) Continuation of application No. PCT/EP2008/000083, filed on Mar. 17, 2008.

(30) Foreign Application Priority Data
May 23, 2007 (NL) 1033879

(51) Int. Cl. A01K 3/00

(52) U.S. Cl. 256/10

(57) ABSTRACT

A mobile support for supporting a wire-shaped terrain demarcation on an area of ground, having a plurality of segments rotatable about an axis. Each segment comprises a spoke having a free end, wherein at least one segment has a greater flexibility in an axial direction than in a direction tangential to the axial direction.

This application is a continuation of international application no. PCT/NL2008/000083 and claims priority from Netherlands application no. 1033879 filed on May 23, 2007. The contents of both applications are hereby incorporated by reference in their entirety.

### BACKGROUND OF THE INVENTION

1. Field of the Invention

The invention relates to a mobile support for supporting a wire-shaped terrain demarcation over on a ground.

2. Description of the Related Art

Such a support is known from the Dutch publication NL 8700723. This publication discloses a wheel with a plurality of spokes which are interconnected by a hub. The hub is connected to an axially orientated tube through which extends the wire to be supported. The wheel is capable of rotating about the wire.

A problem with such a device is that, in the case of axial forces on the wire, the wheel offers great resistance to a movement or displacement in an axial direction, which may thus lead to breakage of the wire or breakage of a spoke. This is in particular a problem if such a wheel is drawn by means of the wire. The wheel may tilt to a considerable extent, drag over the ground, etc.

### SUMMARY OF THE INVENTION

The invention aims at providing a mobile support which allows movement over the ground in an axial direction.

This is achieved by means of a mobile support of the above-mentioned type, wherein at least one segment has a greater flexibility in an axial direction than in a direction tangential to the axial direction. When a pulling force is exerted on the support in an axial direction via the terrain demarcation, the segment which is in contact with the ground at its free end will bend, and the support, with the exception of the segment, will move sideward. When the support subsequently rotates by a force in the plane of rotation, the next segment will come into contact with the ground in a position in which it has been shifted sideward in relation to the former segment. In this manner, the mobile support will yield to lateral force and, under the influence thereof, a smooth lateral movement will occur. It may be sufficient for one segment to have such a greater flexibility, and not for the other ones.

Advantageously, a plurality of segments, and preferably all segments, have such a greater flexibility.

The spoke preferably comprises a pivot. In this case, the pivot may be disposed near the axis of rotation, or at any place on the spoke. It provides much freedom in the choice of material for the spoke.

In a particular embodiment according to the invention, the segment, and in particular the spoke, consists at least partially of flexible material. This allows a simple and cheap construction.

In particular, the spoke is oblate in the direction perpendicular to the axis. Such an embodiment enables in a simple manner that the preferred direction of bending is the axial direction.

In a particular embodiment, the spoke tapers outward in a radial direction. This construction ensures that the maximum deflection occurs at the outer side near the circumference of the support.

In a further favorable embodiment, the segment is electrically conductive. In the case when a suitable electric tension is applied to the terrain demarcation and/or the support, animals which come into contact with the support will thus be deterred. As a result thereof, the support will not be touched and will fulfill its function.

In this context, it is further advantageous if the segment is capable of being brought into electric contact with the terrain demarcation, depending on the position of rotation of the segment. As a result thereof, it is ensured that only particular segments will be under electric tension and it is possible to prevent the current from leaking via the spokes which are in contact with the ground. An example of features suitable for this purpose is described in NL 8700723, which is incorporated herein by reference.

The terrain demarcation is, for example, a wire, preferably an electrically conductive wire, such as metal wire, but may also comprise, for example, a ribbon or the like.

In a particular embodiment, the segment comprises a tread, which tread, viewed in an axial direction, is wider than the spoke. Such a tread prevents the segment from penetrating deep into the ground and thus becoming more difficult to move. By making the spoke relatively narrow, the spoke will move easily through grass and the like.

In a further embodiment of the invention, the tread extends in both tangential directions relative to the spoke, preferably extending nearly to adjacent treads. Such a construction enables a substantially completely closed circumference, so that the support can smoothly roll over the ground. This effect is reinforced if the curvature of the tread is substantially equal to the curvature of the circumference of the mobile support. However, a smaller or, on the contrary, greater local curvature is also possible.

In particular, the support comprises a central hub to connect the spokes.

In a further embodiment of the invention, the terrain demarcation is capable of being passed through the hub. This makes it possible to connect the support to the demarcation without the demarcation having to be broken. For this purpose, the hub comprises in particular a recess extending in radial direction to pass the terrain demarcation from the outside to the core of the hub. In this manner it is possible to place the support in a simple manner, without auxiliary means, around the demarcation.

The support comprises in particular a fastening for the terrain demarcation. This keeps the support always in a fixed position on the demarcation and prevents, for example, adjacent supports from moving towards each other. Such a fastening may take place in a simple manner by means of a hook, clamp or the like.

It is further advantageous if the fastening is movable in an axial direction relative to the hub. This ensures that sudden jerks made by the terrain demarcation to the support can be absorbed. In this case, the position of rest remains preferably unchanged, and thus unshifted. Disposing the fastening movably may, for example, take place by means of a spring.

In a further favorable embodiment of the invention, the hub comprises a tubular element orientated in an axial direction. By passing the demarcation through this tubular element the support will not easily fall down. In a tilted position of the support, the tubular element will also assume a tilted orientation. This ensures that extra tensile stress will be applied to the demarcation, and will thus keep the support upright.

The invention also relates to an assembly for supporting a wire-shaped terrain demarcation on a ground, comprising a first and a second mobile support according to the invention, wherein the supports are interconnected by means of at least one tubular element. Such an assembly will remain independently in a stable position on the ground. This means that the tensile stress need not be applied to the demarcation to keep the mobile support upright. In this case, it is also sufficient if only one tubular element is provided for the two supports together.

The invention further relates to a terrain demarcation system comprising a wire-shaped terrain demarcation and a mobile support according to the invention. The invention is not limited to fencing for use in a pasture, but is, for example, also suitable for supporting a mobile demarcation for parking places and the like. In the case of such systems a smooth lateral movability is favorable. Preferably, the terrain demarcation system comprises at least one terrain demarcation displacing device, such as a small wagon. Preferably, the terrain demarcation displacing device is self-propelled. In this case, the greater flexibility and insusceptibility to interference are advantageous.

### BRIEF DESCRIPTION OF THE DRAWINGS

The invention will be explained hereinafter in further detail with reference to an embodiment shown in the drawing, in which:

FIG. 1 is a side view of a support according to the invention; and

FIG. 2 is a front view of a support according to the invention.

### DESCRIPTION OF ILLUSTRATIVE EMBODIMENTS

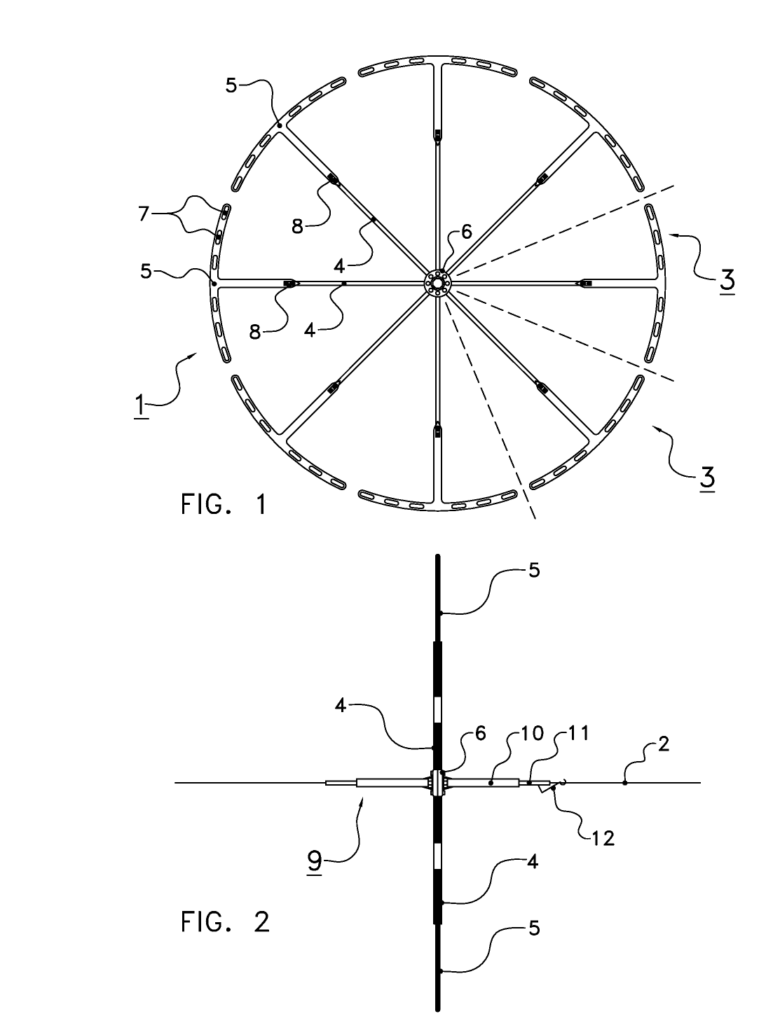

The following is a description of certain embodiments of the invention, given by way of example only and with reference to the drawings. In FIG. 1 is depicted a mobile support 1 for supporting a wire-shaped terrain demarcation (not visible here) on a ground, having a plurality of segments 3 rotatable about an axis, wherein each segment comprises a spoke 4 having a free end, wherein at least one segment has a greater flexibility in an axial direction than in a direction tangential to the axial direction. The segment 3 consists at least partially of flexible material and comprises here a spoke 4 and a tread 5. The tread is made of flexible material. The spoke is oblate in the axial direction near the circumference, and provided with a pivot 8 which connects the spoke to the tread. The pivot 8 can effect a pivoting lateral movement.

The curvature of the tread 5 is equal to the curvature of the circumference of the mobile support 1. The support comprises a central hub 6 to connect the spokes 4. The terrain demarcation 2 is capable of being passed through the hub 6.

Apertures 7 are provided in the segment 3 in order to save material and to make the support lighter.

In a not shown embodiment, the segment 3 is capable of being brought into electric contact with the terrain demarcation, depending on the position of rotation of the segment. Such an embodiment has been described extensively in Dutch publication NL 8700723, which is incorporated herein by reference in its entirety, and will not be explained in further detail. The segment itself may be made of electrically conductive material, such as spring steel. However, it is also possible that a conductive strip or wire is disposed on the segment at the outer side thereof.

FIG. 2 is a front view of the support 1 according to the invention. The segment 3 comprises a tread 5, which tread 5, viewed in axial direction, is wider than the spoke 4. This tread is supported on the ground and extends in both tangential directions relative to the spoke (FIG. 1). The hub comprises a tubular element 9 orientated in the axial direction.

This tubular element comprises a first portion 10 having a great diameter in which a second portion 11 having a smaller diameter is movably fastened. These are disposed on both sides of the plane of the segments. The support further comprises a fastening for the terrain demarcation 2. This fastening is disposed on both sides as a hook 12 about which the demarcation is coiled. Owing to the fact that the hook 12 is connected to the second portion 11, the fastening is movable to some extent relative to the hub 6. A not depicted spring is disposed in the first portion 10 and keeps the second portion 11 in position.

The terrain demarcation may be used, for example to pasture animals. Such a system comprises one or a plurality, but preferably two, automatically movable vehicles which serve as tensioning points for the terrain demarcation. In order to limit sagging of the demarcation 2 between the tensioning points, a support according to the invention is disposed at one or a plurality of places between the tensioning points. Sagging should be limited, because the demarcation should not be too low in order to prevent animals from stepping over the demarcation. The height of the demarcation above the ground and thus the distance from the point of rotation to the ground is, for example, approximately 90 cm for cattle. When a vehicle moves, it displaces the demarcation which, itself, takes along the support. Such a pasturing system, provided with another support, has been described extensively in U.S. Pat. Nos. 6,929,252 and 7,573,223, the contents of which are hereby incorporated by reference in their entireties.

The use of the support is not limited to a wire demarcation, but is also suitable for any other kind of terrain demarcation, such as a rope, strip, chain or bar.

Thus, the invention has been described by reference to certain embodiments discussed above. It will be recognized that these embodiments are susceptible to various modifications and alternative forms well known to those of skill in the art. Accordingly, although specific embodiments have been described, these are examples only and are not limiting upon the scope of the invention. The person skilled in the art will be able to apply various modifications and adaptations within the scope of the invention, the scope of protection for the invention being determined by the accompanying claims.

What is claimed is:

1. A mobile support for supporting a wire-shaped terrain demarcation on a ground, having a plurality of segments rotatable about an axis, wherein each segment comprises a spoke having a free end, and at least one segment has a greater flexibility in an axial direction than in a direction tangential to the axial direction.

2. The mobile support according to claim 1, wherein the spoke comprises a pivot.

3. The mobile support according to claim 1, wherein the segment consists at least partially of a flexible material.

4. The mobile support according to claim 3, wherein the spoke consists at least partially of a flexible material.

5. The mobile support according to claim 1, wherein the spoke is oblate in a direction perpendicular to the axis.

6. The mobile support according to claim 1, wherein the spoke tapers in a radial direction.

7. The mobile support according to claim 1, wherein the segment is electrically conductive.

8. The mobile support according to claim 7, wherein the segment is capable of being brought into electric contact with the terrain demarcation, in dependence on the position of rotation of the segment.

9. The mobile support according to claim 1, wherein the segment comprises a tread which, viewed in an axial direction, is wider than the spoke.

10. The mobile support according to claim 9, wherein the tread extends in both tangential directions relative to the spoke.

11. The mobile support according to claim 9, wherein the curvature of the tread is substantially equal to the curvature of the circumference of the mobile support.

12. The mobile support according to claim 1, wherein the support comprises a central hub to connect the spokes.

13. The mobile support according to claim 12, wherein the terrain demarcation is capable of being passed through the hub.

14. The mobile support according to claim 13, wherein the hub comprises a recess extending in a radial direction to pass the terrain demarcation from the outside to the core of the hub.

15. The mobile support according to claim 12, wherein the support comprises a fastening for the terrain demarcation.

16. The mobile support according to claim 15, wherein the fastening is movable in an axial direction relative to the hub.

17. The mobile support according to claim 12, wherein the hub comprises a tubular element orientated in an axial direction.

18. An assembly for supporting a wire-shaped terrain demarcation on a ground, comprising a first and a second mobile support according to claim 17, wherein the supports are interconnected by means of at least one tubular element.

19. A terrain demarcation system comprising a wire-shaped terrain demarcation and a mobile support according to claim 1.

20. A terrain demarcation system according to claim 19, comprising a terrain demarcation displacement device.

21. A terrain demarcation system according to claim 20, wherein the terrain demarcation displacement device is self-propelled.
